(19) United States
(12) Patent Application Publication
(10) Pub. No.: US 2014/0232090 A1
(43) Pub. Date: Aug. 21, 2014

(54) AIRBAG DEVICE FOR VEHICLE

(71) Applicant: SUZUKI MOTOR CORPORATION, Shizuoka-ken (JP)

(72) Inventors: Shinsuke Yoshitake, Shizuoka-ken (JP); Kazushige Fukushima, Shizuoka-ken (JP)

(73) Assignee: SUZUKI MOTOR CORPORATION, Shizuoka-ken (JP)

(21) Appl. No.: 14/133,033

(22) Filed: Dec. 18, 2013

(30) Foreign Application Priority Data
Feb. 21, 2013 (JP) 2013-031772

(51) Int. Cl. B60R 21/20

(52) U.S. Cl. CPC B60R 21/20
USPC 280/728.2

(57) ABSTRACT

An inflator for supplying a gas into an airbag body in a collision of a vehicle is mounted on a peripheral edge portion of a roof of a vehicle body through a bracket, the bracket is formed having a long plate shape along the peripheral edge portion of the roof, a fixing portion of the bracket on which the inflator is fixed and a mounting portion of the bracket to be mounted on the peripheral edge portion of the roof are juxtaposed in a longitudinal direction of the bracket, and a fixed surface of the fixing portion is inclined so as to be located closer to a cabin exterior as it goes closer to the upper side with respect to a mounted surface of the mounting portion.

### TECHNICAL FIELD

The present invention relates to an airbag device for a vehicle, in which

an inflator for supplying a gas into an airbag body in a collision of the vehicle is mounted on a peripheral edge portion of a roof of the vehicle body through a bracket;

the bracket is formed having a long plate shape along the peripheral edge portion of the roof; and

a fixing portion of the bracket to which the inflator is fixed and a mounting portion of the bracket to be mounted on the peripheral edge portion of the roof are juxtaposed in a longitudinal direction of the bracket.

### BACKGROUND ART

In the vehicle provided with the aforementioned airbag device, there is a concern that the head of a passenger may be brought into contact with the inflator, which is made of metal and having high hardness by an impact force in a collision of the vehicle. Thus, the bracket is deformed so as to have the impact force absorbed.

As an example thereof, as disclosed in Patent Literature 1, the inflator has been supported on the vehicle body through the plate-shaped bracket in a cantilever manner. Then, a flat plate portion between the fixing portion of the bracket on which the inflator is fixed and the mounting portion of the bracket to be mounted on the peripheral edge portion of the roof have been configured to be bent and deformed in a collision of the vehicle.

In this technology, a fixed surface of the fixing portion of the bracket and a mounted surface of the mounting portion of the bracket substantially cross each other at a right angle.

### CITATION LIST

### Patent Literature

[Patent Literature 1] Japanese Unexamined Patent Application Publication No. 2010-235043

### SUMMARY OF INVENTION

### Problem to be Solved by the Invention

According to the aforementioned prior-art structure, since the fixed surface of the fixing portion of the bracket and the mounted surface of the mounting portion of the bracket substantially cross each other at a right angle, the flat plate portion between the fixing portion and the mounting portion can resist the impact force in a collision of the vehicle to some degree, and there was room for improvement in terms of absorbing performance of the impact force.

The present invention has as an object to provide an airbag device for a vehicle that can improve absorbing performance of the impact force in a collision of the vehicle.

### Means for Solving the Problem

Features of the present invention are that

in an airbag device for a vehicle, in which

an inflator for supplying a gas into an airbag body in a collision of a vehicle is mounted on a peripheral edge portion of a roof of a vehicle body through a bracket;

the bracket is formed having a long plate shape along the peripheral edge portion of the roof; and

a fixing portion of the bracket on which the inflator is fixed and a mounting portion of the bracket to be mounted on the peripheral edge portion of the roof are juxtaposed in a longitudinal direction of the bracket,

a fixed surface of the fixing portion of the bracket is inclined so as to be located closer to the exterior of a cabin as it goes closer to the upper side with respect to a mounted surface of the mounting portion of the bracket.

According to the aforementioned configuration, since the fixed surface of the fixing portion of the bracket is inclined so as to be located closer to the exterior of the cabin as it goes closer to the upper side with respect to the mounted surface of the mounting portion of the bracket, the fixing portion of the bracket can be inclined to the exterior of the cabin and be deformed easily by the impact force in a collision of the vehicle. Therefore, the absorbing performance of the impact force can be improved.

Since the fixing portion of the bracket is inclined to the exterior of the cabin, the airbag body can be moved to the upper side, and a space in the cabin for the head part of the passenger can be expanded. As a result, the head part of the passenger can be protected.

In the present invention,

if the fixing portion is provided in an intermediate portion in the longitudinal direction of the bracket; and

if the mounting portion is provided on both sides of the fixing portion of the bracket, the following actions can be exerted.

The inflator can be stably supported on the peripheral edge portion of the roof through the bracket. As a result, the fixing portion of the bracket can be inclined to the exterior of the cabin (cabin exterior) and be deformed more easily by the impact force in a collision of the vehicle.

In the present invention,

if the fixing portion is formed by twisting the intermediate portion in the longitudinal direction of the bracket, the following action can be exerted.

For example, concentration of stress at a bent portion can be prevented as compared with means for bending the bracket so that the fixed surface of the fixing portion is located closer to the exterior of the cabin as it goes closer to the upper side with respect to the mounted surface of the mounting portion. Moreover, deformation along the twist in the collision of the vehicle can be easily promoted, and the fixing portion can be smoothly deformed.

In the present invention,

if the bracket is formed to be longer than the inflator, and

if the intermediate portion in the longitudinal direction of the bracket portion other than the fixing portion is inclined so as to be located closer to the exterior of the cabin as it goes closer to the upper side with respect to the remaining portion of the bracket portion, the following action can be exerted.

If the inflator is inclined and brought into contact with the bracket due to inclination and deformation of the fixing portion at the collision of the vehicle, the intermediate portion in the longitudinal direction of the bracket portion other than the fixing portion is inclined and deformed so as to absorb the impact force.

In the present invention,

if the airbag body, folded so as to follow the peripheral edge portion of the roof, is fixed to the bracket, the following action can be exerted.

The inflator and the folded airbag body can be packed in a compact way, and an accommodating space into an interior member such as a roof lining can be made compact.

### Advantageous Effects of Invention

According to the present invention, an airbag device for a vehicle, which can improve absorbing performance of impact force in the collision of the vehicle, is provided.

### BRIEF DESCRIPTION OF DRAWINGS

FIG. 1 is a view of an airbag device of a vehicle when seen from the inside of a cabin.

FIG. 2 is an enlarged view of a Z portion in FIG. 1.

FIG. 3 is an A-A sectional view of FIG. 2 (sectional view in which components on the vehicle body side are omitted).

FIG. 4(a) is a view of a bracket seen from the inside of the cabin, FIG. 4(b) is a view of the bracket when seen from above, and FIG. 4(c) is a side view of the bracket.

FIG. 5 is the A-A sectional view of FIG. 2.

FIG. 6 is the A-A sectional view of FIG. 2 and a sectional view illustrating a deformation direction of a fixing portion of the bracket.

FIG. 7 is a view illustrating a first alternative embodiment.

FIG. 8 is a view illustrating a second alternative embodiment and an F arrow view of FIG. 7.

FIG. 9 is a view illustrating a third alternative embodiment and a G arrow view of FIG. 7.

FIG. 10 is a sectional view illustrating a structure of a first comparative example and a view corresponding to the A-A sectional view of FIG. 2.

FIG. 11 is a sectional view illustrating a structure of a second comparative example and a view corresponding to the A-A sectional view of FIG. 2.

FIG. 12 is a sectional view illustrating a structure of a third comparative example and a view corresponding to the A-A sectional view of FIG. 2.

### MODE FOR CARRYING OUT THE INVENTION

An embodiment for putting the present invention into practice will be described below on the basis of the attached drawings.

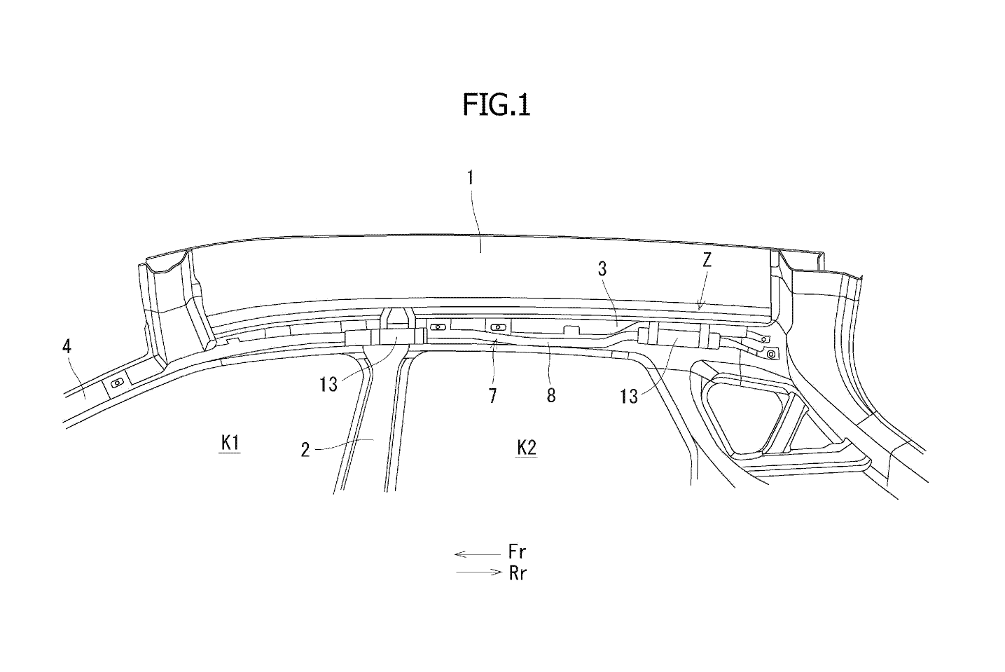

As illustrated in FIGS. 1 to 3 and 5, a curtain airbag device 7 is mounted on a roof side rail 3 (corresponding to a peripheral edge portion of a roof of a vehicle body) of an automobile. The curtain airbag device 7 is located on the back side of a roof lining 16.

### Structure of Curtain Airbag Device 7

The curtain airbag device 7 is provided with a bag-shaped airbag body 9 folded so as to follow the roof side rail 3 and an inflator 8 for supplying a gas into the airbag body 9 at a collision of the vehicle. A plurality of spots in a longitudinal direction of the folded airbag body 9 are accommodated in a plurality of accommodating bodies 13 each having a U-shaped section with the open upper side, respectively. Reference numeral 2 in FIG. 1 denotes a center pillar, reference numeral 4 denotes a front pillar, reference numeral 1 denotes a roof, reference character K1 denotes an opening for a front door, reference character K2 denotes an opening for a rear door, reference character Fr denotes the vehicle front side, and reference character Rr denotes the vehicle rear side.

The airbag body 9 is mounted on the roof side rail 3 so as to be located across an upper part on the side portion of a front seat and an upper part on the side portion of a rear seat. When a gas is supplied into the airbag body 9 from the inflator 8 at a collision of the vehicle, the airbag body 9 instantaneously descends between the passenger and the vehicle body side portion while inflating and expanding, and protects the passenger.

The inflator 8 is mounted on a rear end portion of the roof side rail 3 through a bracket 10. This inflator 8 is located on upper rear part on the side portion of the rear seat. The bracket 10 and the inflator 8 are both made of metal. The inflator 8 is formed of metal having high hardness.

### Structure of Bracket 10

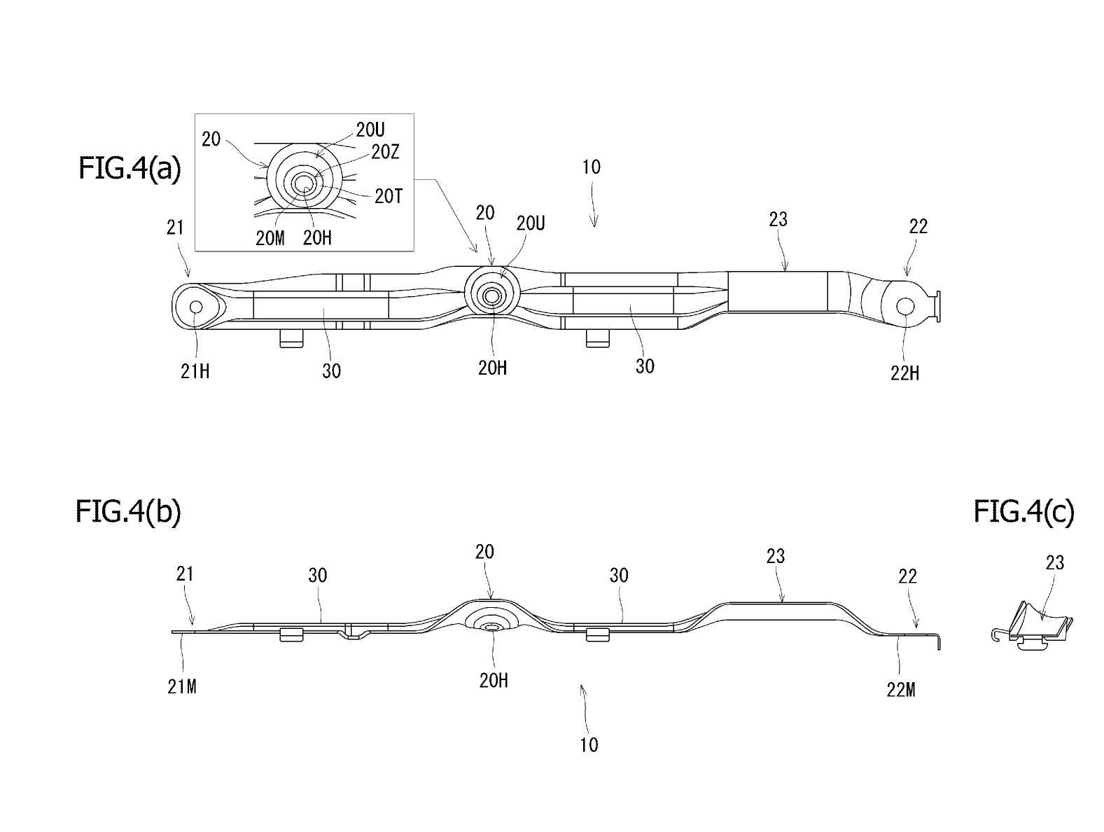

As illustrated in FIGS. 4(a) to 4(c), the bracket 10 is formed having a long plate shape along the roof side rail 3 and is formed longer than the inflator 8. A fixing portion 20 of the bracket 10 on which the inflator 8 is fixed is provided on an intermediate portion in a longitudinal direction of the bracket 10.

### Structure of Fixing Portion 20 of Bracket 10

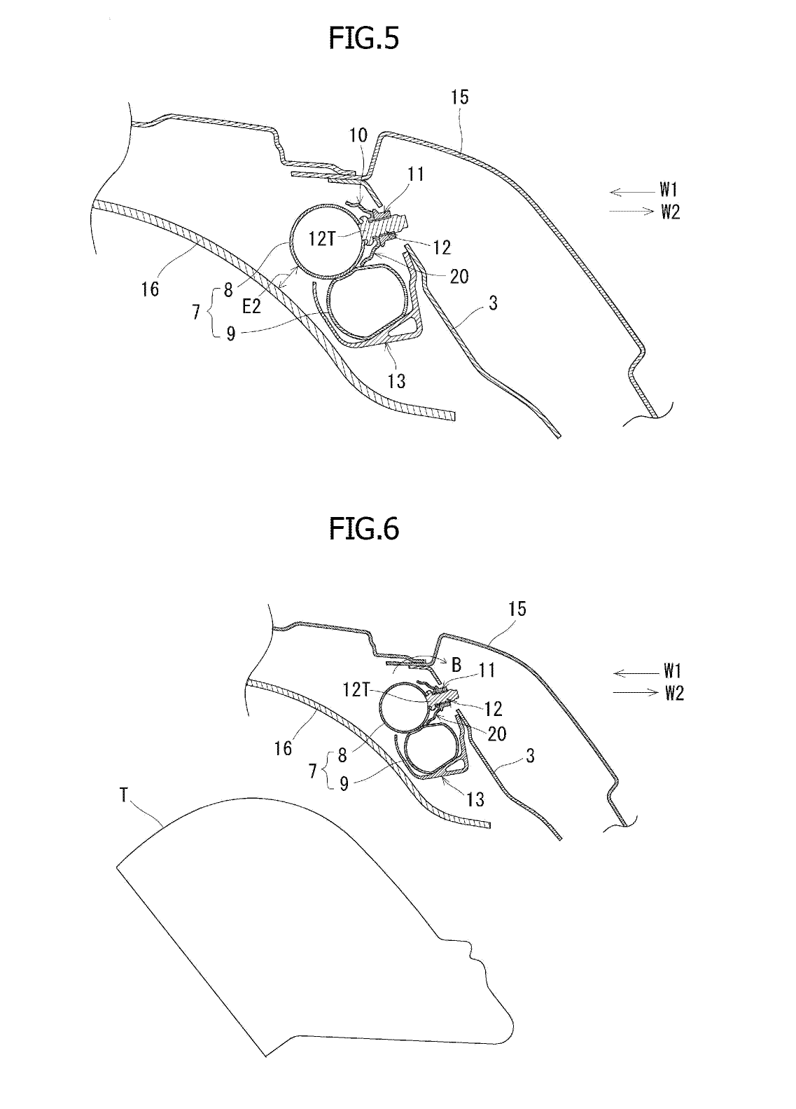

In more detail, as illustrated in FIG. 3 and in FIGS. 4(a) to 4(c), a stepped recess portion 20U having a circular sectional shape is formed on an intermediate portion in the longitudinal direction of the bracket 10. The recess portion 20U is recessed from a cabin inside W1 toward a cabin exterior W2 (See FIG. 5). A first bolt insertion hole 20H is formed in a bottom wall 20T of the recess portion 20U. Moreover, a peripheral portion of the first bolt insertion hole 20H rises to the side opposite to the recess direction of the recess portion 20U. As described above, the fixing portion 20 is formed.

A rising portion on the peripheral part of the first bolt insertion hole 20H is configured as a receiving seat 20Z (See FIG. 3) receiving and supporting a head part 12T of a bolt 12 on the inflator 8 side. A seat surface of the receiving seat 20Z is configured as a fixed surface 20M on which the inflator 8 is fixed. The bracket 10 having the aforementioned configuration is formed by pressing a single plate material. As a result, the bracket 10 can be easily manufactured, and a manufacturing cost of the bracket 10 can be reduced.

### Fixed Structure of Inflator 8 to Bracket 10

As illustrated in FIG. 3, the head part 12T of the bolt 12 of the inflator 8 is fastened, and the bolt 12 protrudes outward in the radial direction of the inflator 8 from an outer peripheral surface of the inflator 8. This bolt 12 is inserted from the recess portion 20U side (the cabin inside WO into the first bolt insertion hole 20H of the fixing portion 20 of the bracket 10. A nut 11 is screwed and finished with a male screw portion of the bolt 12, and the inflator 8 is fixed to the fixing portion 20 of the bracket 10.

### Structure of First Mounting Portion 21 and Second Mounting Portion 22 of Bracket 10

As illustrated in FIGS. 4(a) and 4(b), a first mounting portion 21 and a second mounting portion 22 to be mounted on the roof side rail 3 are provided, respectively, on both end portions in the longitudinal direction of the bracket 10. That is, the first mounting portion 21 and the second mounting portion 22 are provided on the both sides of the fixing portion 20 of the bracket 10. The fixing portion 20, the first mounting portion 21, and the second mounting portion 22 are juxtaposed at intervals in the longitudinal direction of the bracket 10.

The first mounting portion 21 is configured by forming a pin insertion hole 21H on one end portion (an end portion of the vehicle front side Fr) in the longitudinal direction of the bracket 10. The second mounting portion 22 is configured by forming a second bolt insertion hole 22H on the other end portion (an end portion of the vehicle rear side Rr) in the longitudinal direction of the bracket 10.

On the bracket portion between the first mounting portion 21 and the fixing portion 20 and the bracket portion between the fixing portion 20 and the second mounting portion 22, a bead 30 extending in the longitudinal direction of the bracket 10 is formed. The bead 30 expands to the side (the cabin inside W1) opposite to the recess direction of the recess portion 20U. As a result, strength of the bracket 10 can be improved.

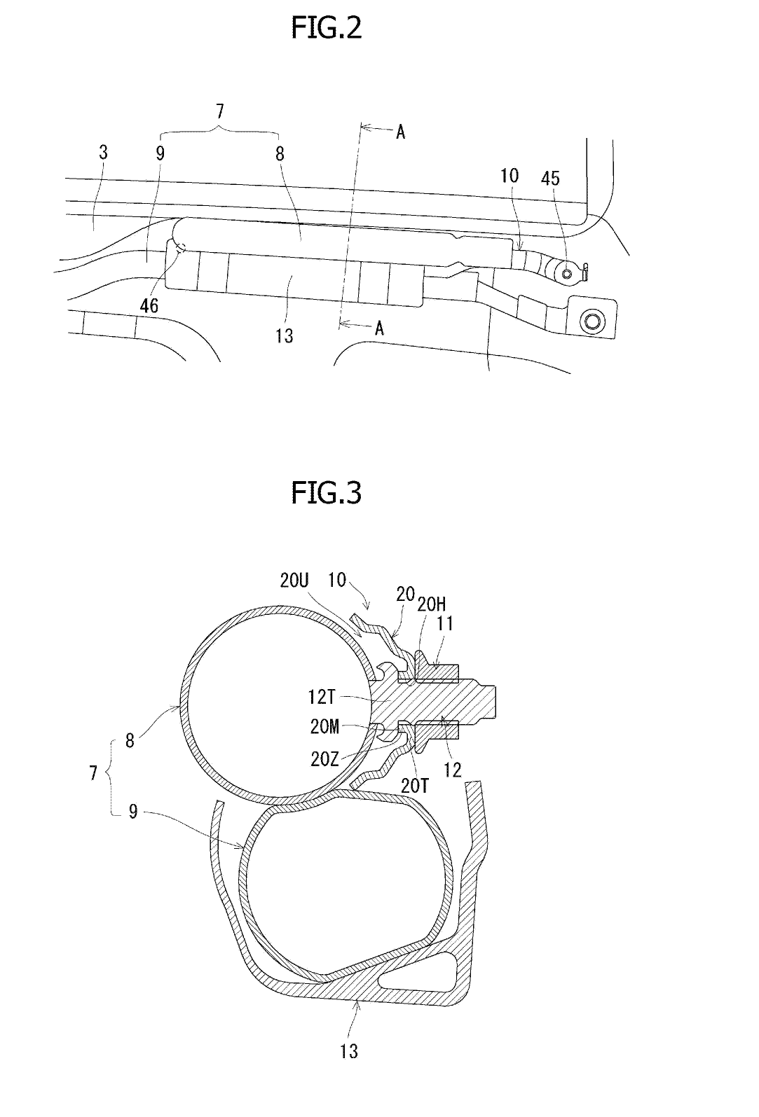

A bolt 45 (See FIG. 2) is inserted from the cabin inside W1 into the second bolt insertion hole 22H of the bracket 10 and is screwed with a female screw portion on the roof side rail 3 side. Moreover, a pin 46 (See FIG. 2) is inserted from the cabin inside W1 into the pin insertion hole 21 H of the bracket 10 and also inserted in a pin hole on the roof side rail 3 side so that the bracket 10 is mounted on the roof side rail 3.

As illustrated in FIGS. 3, 4(a) to 4(c), and 5, the fixing portion 20 is inclined so as to be located closer to the cabin exterior W2 as it goes closer to the upper side with respect to the first mounting portion 21 and the second mounting portion 22 of the bracket 10. In more detail, the fixed surface 20M of the fixing portion 20 is inclined so as to be located closer to the cabin exterior W2 as it goes closer to the upper side with respect to a mounted surface 21M of the first mounting portion 21 and a mounted surface 22M of the second mounting portion 22.

As illustrated in FIG. 6, if the head part T of the passenger is brought into contact with the inflator 8 through the roof lining 16 by the impact force at the collision of the vehicle, the fixing portion 20 of the bracket 10 can be inclined and deformed to a B direction (the cabin exterior W2). Therefore, the absorbing performance of the impact force can be improved.

As described above, by means of the inclination and deformation in the B direction of the fixing portion 20 of the bracket 10, the airbag body 9 can be moved to the upper side, and a space in the cabin for the head part T of the passenger can be expanded. As a result, the head part of the passenger can be protected.

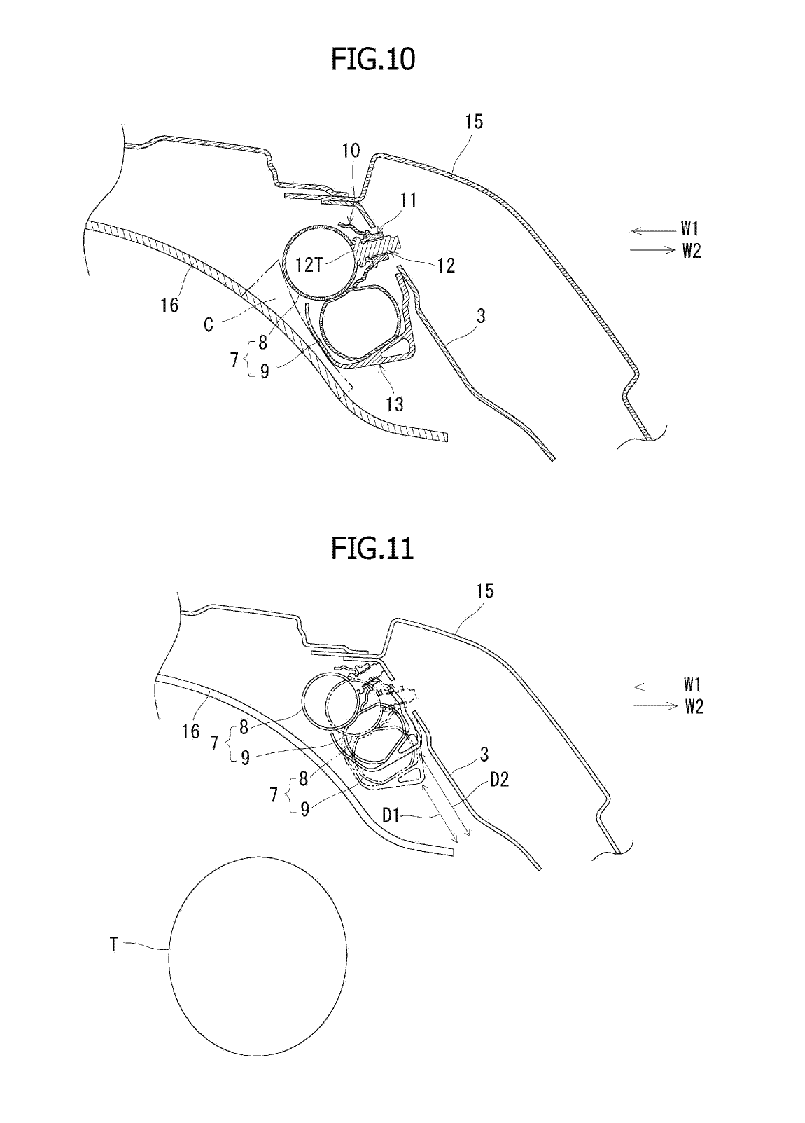

For example, in the case of a structure in a first comparative example in which the bracket 10 not having an impact absorbing function according to the present invention is employed, as illustrated in FIG. 10, an impact buffering component needs to be arranged in a space C between the roof lining 16 and the curtain airbag device 7. As a result, the number of components, cost, and weight are all increased. Moreover, in the structure of the aforementioned first comparative example, the roof lining 16 might intrude into the passenger side in order to ensure a space for the impact buffering components, and a passenger space in the cabin is degraded.

On the other hand, according to the configuration of the present invention, there is no need to arrange the impact buffering component, the number of components, the cost, and the weight can be reduced, and moreover, the roof lining 16 does not intrude into the passenger side, and the space on the passenger side in the cabin is not degraded.

As a structure of a second comparative example, as illustrated in FIG. 11, a structure for protecting the passenger in which the inflator 8 is set at a position above and away from the head part T of the passenger can be considered. However, in the structure in the second comparative example, an inflation and expansion position of the airbag body 9 is set on an upper part of the vehicle. Thus, a distance D2 between the head part T of the passenger and the curtain airbag device 7 becomes larger than the distance D1 in the configuration of the present invention (D2>D1), and there is a concern that sufficient inflation and expansion performance of the airbag body 9 cannot be obtained (In FIG. 11, a two-dot chain line indicates the airbag device 7 of the present invention, while a solid line indicates the airbag device 7 of the structure in the second comparative example).

On the other hand, according to the aforementioned structure of the present invention, since the fixing portion 20 of the bracket 10 is inclined as above, the position of the inflator 8 can be set on the upper part of the vehicle without changing the position of the curtain airbag device 7, as illustrated in FIG. 5. As a result, the space on the passenger side can be ensured to the maximum without losing the inflation and expansion performance of the airbag body 9.

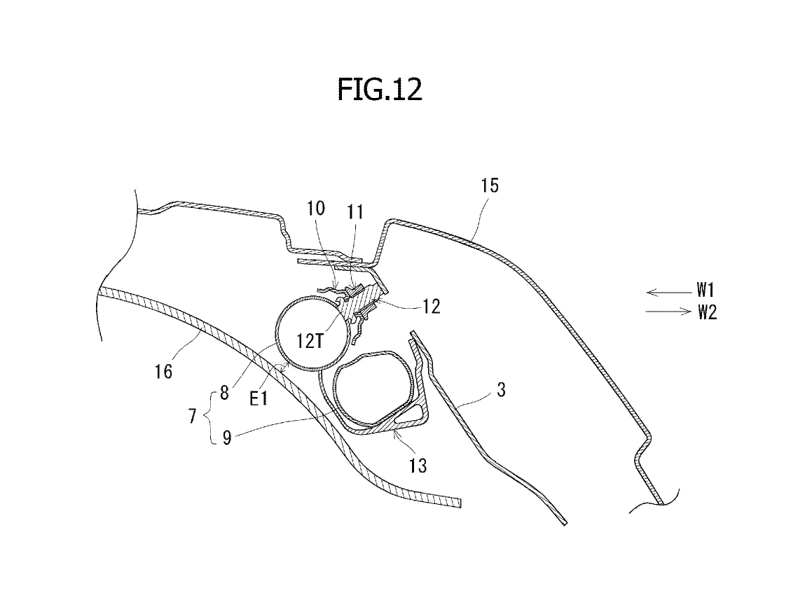

As a structure of a third comparative example, as illustrated in FIG. 12, a structure in which a distance E1 between the inflator 8 and the roof lining 16 is made shorter can be considered. However, in the structure of the third comparative example, it is likely that the inflator 8 and the roof lining 16 are brought into contact with each other during running. Thus, there is a concern that noise may be generated during running, and quality might be degraded, which is undesirable. On the other hand, according to the configuration of the present invention, as illustrated in FIG. 5, a distance E2 between the inflator 8 and the roof lining 16 does not have to be made shorter (E2>E1). Therefore, the aforementioned nonconformity can be avoided.

### Formation of Fixing Portion 20

As illustrated in FIGS. 4(a) to 4(c), the fixing portion 20 is formed by twisting (turning) the intermediate portion in the longitudinal direction of the bracket 10. As a result, the following action can be exerted.

For example, as compared with means for bending the bracket 10 so that the fixed surface 20M of the fixing portion 20 is located closer to the cabin exterior W2 as it goes closer to the upper side with respect to the mounted surface 21 M of the first mounting portion 21 and the mounted surface 22M of the second mounting portion 22, concentration of stress at a bent portion can be prevented. Moreover, deformation can easily occur along the twist in a collision of the vehicle, and the fixing portion can be deformed smoothly.

As illustrated in FIGS. 4(a) to 4(c), the intermediate portion in the longitudinal direction of the bracket portion other than the fixing portion 20 is formed into an inclined portion 23 inclined so as to be located closer to the cabin exterior W2 as it goes closer to the upper side with respect to the remaining portions of the bracket portion. The inclined portion 23 is located between the first bolt insertion hole 20H and the second bolt insertion hole 22H and is located on the side closer to the second bolt insertion hole 22H.

As a result, if the inflator 8 is inclined and is brought into contact with the bracket 10 due to deformation of the fixing portion 20 at the collision of the vehicle, the impact force can be absorbed by inclination and deformation of the inclined portion 23. The inclined portion 23 is also formed by twisting the intermediate portion in the longitudinal direction of the bracket portion other than the fixing portion 20.

The airbag body 9, folded so as to follow the roof side rail 3, is fixed to the bracket 10. As a result, the inflator 8 and the folded airbag body 9 can be made compact, and the accommodating space to the interior member such as the roof lining 16 can be made compact.

### Another embodiment

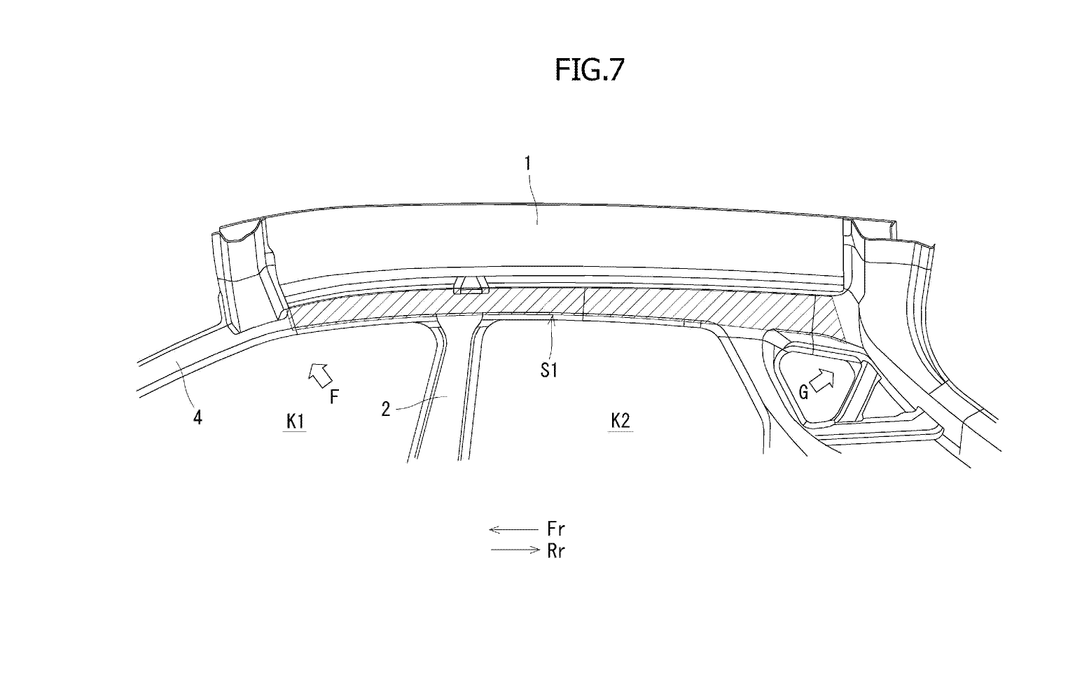

(1) As illustrated in FIG. 7, the inflator 8 may be mounted at any spot in a portion S1 (a hatched portion) including a front end portion or the intermediate portion in the longitudinal direction of the roof side rail 3 through the bracket.

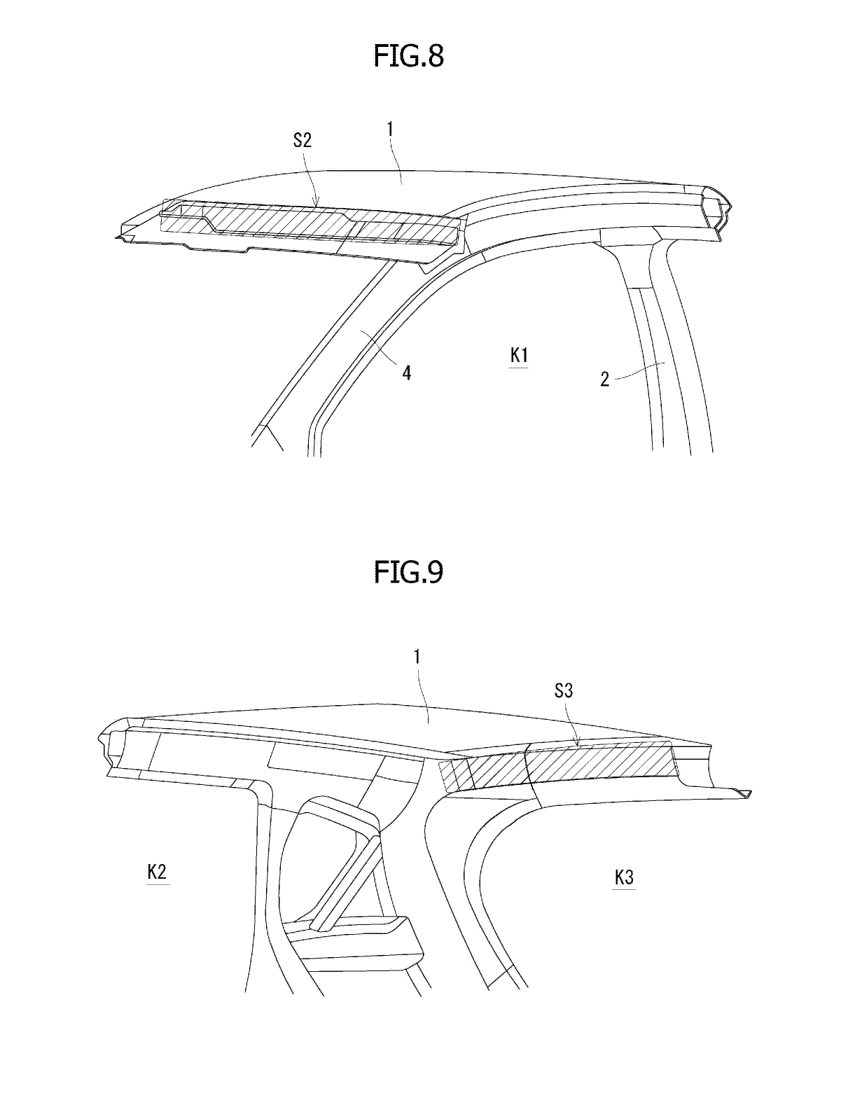

(2) As illustrated in FIG. 8, the inflator 8 may be mounted on a front edge portion S2 (a hatched portion) of the roof 1 of the vehicle body through the bracket.

(3) As illustrated in FIG. 9, the inflator 8 may be mounted on a rear edge portion S3 (hatched portion) of the roof of the vehicle body through the bracket. Reference character K3 in FIG. 9 denotes an opening for a back door.

### REFERENCE SIGNS LIST

1 roof

3 peripheral edge portion of roof (roof side rail)

8 inflator

9 airbag body

10 bracket

20 fixing portion

20M fixed surface

21 mounting portion (first mounting portion)

22 mounting portion (second mounting portion)

21 M mounted surface (mounted surface of first mounting portion)

22 M mounted surface (mounted surface of second mounting portion)

W2 cabin exterior

1. An airbag device for a vehicle in which an inflator for supplying a gas into an airbag body in a collision of a vehicle is mounted on a peripheral edge portion of a roof of a vehicle body through a bracket;
said bracket is formed having a long plate shape along the peripheral edge portion of said roof; and
a fixing portion of said bracket on which said inflator is fixed and a mounting portion of said bracket to be mounted on the peripheral edge portion of said roof are juxtaposed in a longitudinal direction of said bracket, wherein
a fixed surface of the fixing portion of said bracket is inclined so as to be located closer to the exterior of a cabin as it goes closer to the upper side with respect to a mounted surface of the mounting portion of said bracket.

2. The airbag device for a vehicle, according to claim 1, wherein
said fixing portion is provided on an intermediate portion in the longitudinal direction of said bracket; and
said mounting portion is provided on both sides of the fixing portion of said bracket.

3. The airbag device for a vehicle, according to claim 2, wherein
said fixing portion is formed by twisting the intermediate portion in the longitudinal direction of said bracket.

4. The airbag device for a vehicle, according to claim 1, wherein
said bracket is formed longer than said inflator; and
the intermediate portion in the longitudinal direction of the bracket portion other than said fixing portion is inclined so as to be located at the exterior of the cabin as it goes closer to the upper side with respect to the remaining portion of said bracket portion.

5. The airbag device for a vehicle, according to claim 1, wherein
said airbag body, folded so as to follow the peripheral edge portion of said roof, is fixed to said bracket.
